(19) United States
(12) Patent Application Publication
(10) Pub. No.: US 2013/0236054 A1
(43) Pub. Date: Sep. 12, 2013

(54) Feature Detection Filter Using Orientation Fields

(71) Applicants: Chris Carmichael, Laguna Niguel, CA (US); Connie Jordan, Laguna Niguel, CA (US); Kristian Sandberg, Boulder, CO (US)

(72) Inventors: Chris Carmichael, Laguna Niguel, CA (US); Connie Jordan, Laguna Niguel, CA (US); Kristian Sandberg, Boulder, CO (US)

(73) Assignee: UBIQUITY BROADCASTING CORPORATION, Irvine, CA (US)

(21) Appl. No.: 13/775,462

(22) Filed: Feb. 25, 2013

Related U.S. Application Data
(60) Provisional application No. 61/603,087, filed on Feb. 24, 2012.

(51) Int. Cl. G06K 9/46

(52) U.S. Cl. CPC G06K 9/4604
USPC 382/103; 382/298; 382/294

(57) ABSTRACT

A target object is found in a target image, by using a computer for determining an orientation field of at least plural pixels of the target image, where the orientation field describes pixels at discrete positions of the target image being analyzed according to an orientation, and location. The orientation field is mapped against an orientation field in model images in a database to compute match values between the orientation field of the target image and orientation field of model images in the database. The match values are thresholded, and those match values that exceed the threshold to are counted to determine a match between the target and the model.

This application claims priority from provisional application No. 61/603,087, filed Feb. 24, 2011, the entire contents of which are herewith incorporated by reference.

### BACKGROUND

Features in images can be detected using electronic filters to find those features. The filters often use a kernel to find images that have parts matching the kernel, or to automatically characterize the image.

Objects can be detected in images using feature description algorithms such as the scale invariant feature transform or SIFT. SIFT is described for example in U.S. Pat. No. 6,711,293. In general, SIFT finds interesting parts in a digital image and defines them according to SIFT feature descriptors, also called key points. The descriptors are stored in a database. Those same images can be recognized in new images by comparing the features from the new image to the database. The SIFT algorithm teaches different ways of matching that are invariant to scale, orientation, distortion, and illumination changes.

### SUMMARY

The present application describes a technique for finding image parts, e.g. logos, in images.

An embodiment describes using a Matched Orientation Field Filter (MOFF) algorithm for object detection.

### BRIEF DESCRIPTION OF THE DRAWINGS

FIGS. 1A, 1B and 1C show logos in images;

FIG. 2 shows an exemplary logo on the top, and the orientation field of that logo on the bottom

FIGS. 3A, 3B and 3C show logos, and orientation fields of those logos

FIG. 4 shows a logo, on the top portion and orientation field of the logo in the middle portion, and thresholded orientation field of the logo at the bottom portion;

FIG. 5 shows orientation fields for a logo found in the actual image; and

FIG. 6 shows a flowchart of operation of the matching technique according to the present application.

### DETAILED DESCRIPTION

Image processing techniques that rely on key-points, such as SIFT, have been very successful for certain types of object detection tasks. Such tasks include matching objects in several overlapping images for the purpose of “stitching” images together. It is also quite successful for detecting certain types of logos.

The SIFT algorithm works quite well for detecting objects with a large amount of detail and texture, which is sufficient in many object recognition issues, such as image stitching and the like. However, the current inventors have found that the SIFT algorithm has not been well-suited for detecting simple objects that have little detail or texture. In experiments carried out by the inventors, SIFT was found to recognize for example large logos that were a major part of the picture, but not to find smaller less detailed logos.

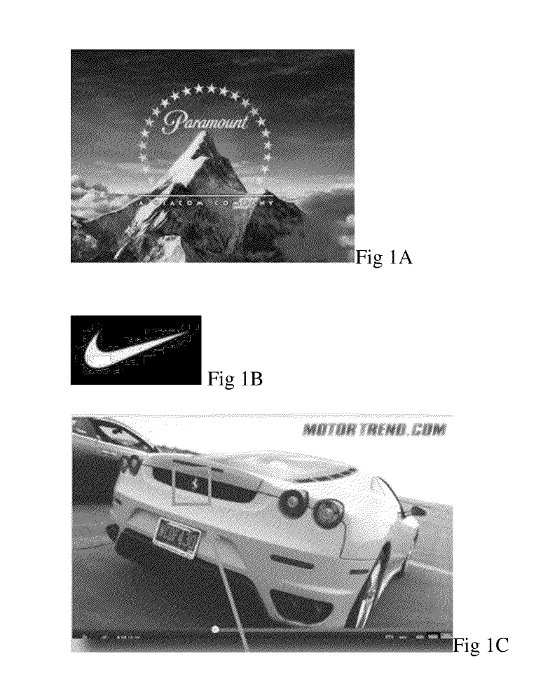

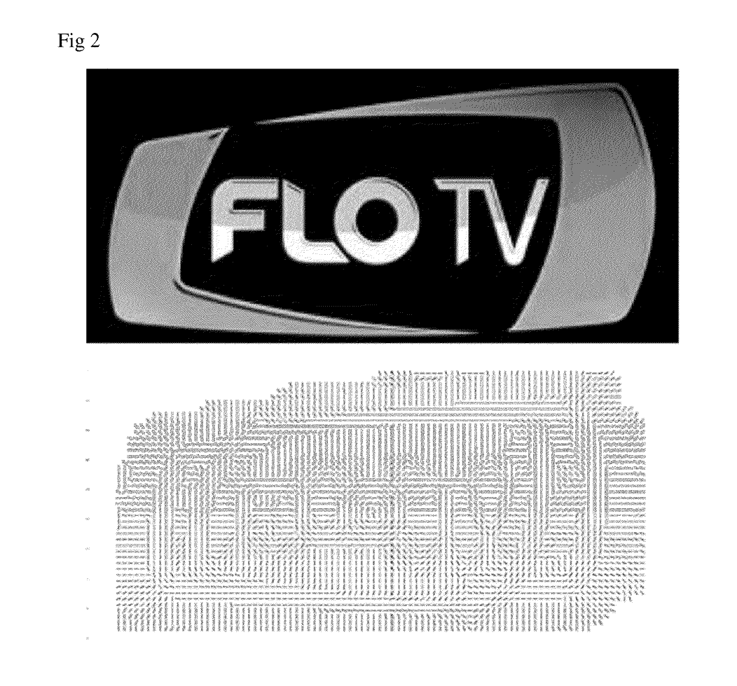

FIGS. 1A and 1B show details of different kinds of images, while FIG. 1A has a lot of detail, and could be usable with SIFT, FIG. 1B is a low detail textureless logo, and the inventors found that SIFT does not work well in this object. Another example is shown in FIG. 1C, where the logo is a very small part of the overall image.

The inventors believe that SIFT does not work well for texture-less objects, because it relies on its detection of local key points in images. The key points are selected such that they contain as much unique information as possible. However, for an object such as the Nike-logo in FIG. 1B, there are few unique details to this image. The key points that the SIFT algorithm may find, may also be present in a wide variety of other objects in the target image. That is, there is not enough uniqueness in the features of simple logos like the logo of FIG. 1B.

The inventors have developed a technique that uses different techniques than that in SIFT, and is particularly useful for detecting texture-less objects, such as the Nike logo in FIG. 1B. The techniques described herein attempts to capture most of the shape attributes of the object. This uses global information in the model, as opposed to the highly localized key points used by SIFT. The global attributes of the object are described using descriptors that are insensitive to color and light variations, shading, compression artifacts, and other image distortions.

The inventors note that SIFT like techniques typically detect key points near “corner-like” features. The inventors have recognized many problems with this approach, which we illustrate in the following sections.

Problem 1: Objects with No or Too Few Key-Points

Some logos do not contain sufficiently many “corner-like” features to produce sufficiently many key-points that SIFT-like methods can use to reliably detect the objects. These objects will often generate no or too few reliable key points to be used reliably by SIFT-like methods in low quality images.

Problem 2: Poorly Resolved Objects

Another problem arises when SIFT-like methods are applied to poorly resolved objects that are heavily pixelized or contain compression artifacts. In such cases, the pixelation effectively introduces “false” corners, which in turn may introduce false key-points. This can severely limit the reliability of SIFT-like methods.

Problem 3: Detection of Generic Object Shapes

Key-point based methods, such as SIFT and its relatives, were not designed to detect “generic object features”, such as a gun shape.

Hence, key-point based methods will not be able to be used for more generic detection problems, such as gun detection.

SIFT-like methods perform well for objects of good quality containing a large amount of details. As we will see in the following sections, MOFF will work on all these types of objects, but is particularly suitable for “difficult” objects, such as objects with little detail, and objects perturbed by artifacts caused by e.g., low resolution or compression.

An embodiment describes feature detection in an image using orientation fields. A special application is described for detecting “texture-less” objects, referring to objects with little or no texture, such as certain corporate logos.

An embodiment describes finding an item in one or more images, where the item is described herein as being a “model image”. A so-called target image is being analyzed to detect occurrences of the model image in the target image.

The embodiment describes assigning a “reliability weight” to each detected object. The reliability weight indicates a calculated probability that the match is valid.

For the purpose of logo detection, the model image in this embodiment can be an image of a logo, and the target image is a (large) image or a movie frame.

Overview of Key-Point Based Algorithms

Key-point based algorithms typically include the following main steps:

Key-point localization

Orientation assignment in a neighborhood around each key-point.

Generation of image descriptors at the key points.

Matching of image descriptors against a data base.

Removal of non-consistent matches and clustering.

The MOFF algorithm generates an orientation field at all pixels in the image. Then, the techniques operate to measure of alignment and auto-correlation of the orientation field with respect to a data base of models.

Key-point based algorithms and the MOFF algorithm both compute orientations. In addition, both use matching step that involve orientations in some way. However, the orientations are defined, computed, and used very differently in the two settings. We will also see that the alignment and auto-correlation measures used by MOFF do not have a corresponding counter-part in the SIFT case.

Due to these differences, the two algorithms are also useful for different object detection tasks. Key-point based algorithms are well suited for matching a large number of detailed, well-resolved objects, and identifying detailed objects in an image. MOFF is well suited for matching few generic objects, with poor resolution and little detail.

A logo often comes in many varieties, including different colors and shadings, so it is important that we can detect all varieties of a logo without having to use every conceivable variation of the logo in our model data base.

Other aspects which are unique to logos are also described. For example, a metallic logo may include reflections from the surroundings in the target image, and consequently a logo detection technique should look for and take into account such reflections.

An orientation field is described herein for carrying out the feature detection. The orientation field may describe the orientations that are estimated at discrete positions of the image being analyzed. Each element in the image, for example, can be characterized according to its orientation and location. An embodiment describes using orientation fields as described herein is a way of describing textureless objects. A scale invariant orientation field is generated representing each logo. After this orientation Field has been generated, a matching orientation fields searched for in the target image.

Let I(x) denote the intensity at location x of the image I. We define an orientation F(x) at the image location x as the pair F(x)={w(x); θ(x)}, where w is a scalar that denotes a weight for the angle θ. The angle θ is an angle between 0 and 180 degrees (the interval [0, π), and the weight w is a real number such that the size of w measures the importance or reliability of the orientation.

We note that whereas the orientations typically used by SIFT-like methods are vectors, the orientations defined here need not be vectors. One way to see this is that the gradient vectors typically used by SIFT-like algorithms have a periodicity of 360 degrees when rotated around a point. The orientations used by MOFF do not have a notion of “forward and backward”, and have a periodicity of 180 degrees when rotated around a point. Consider the family of curves defined by

{r_{θ}(s)}_{θ}={s cos θ\hat{x}+s sin θŷ}_{θ}

where θε[0,π) and sε[−L/2,L/2]. This curves describe straight lines of length L tilted at angle θ.

We now generate an integral field S of an image I by

$$S ( x , θ ) = {\int }_{- \frac{L}{2}}^{\frac{L}{2}} I ( x + {r}_{θ} ( s ) ) d s$$

Given these integrals, we next generate our orientations by

$$w ( x ) = {max}_{φ ∈ [ 0 , π )} {\int }_{0}^{π} K ( φ , μ ( x ) ) S ( x , μ ) d μ$$

$$and$$

$$θ ( x ) = arg {max}_{φ ∈ [ 0 , π )} {\int }_{0}^{π} K ( φ , μ ( x ) ) S ( x , μ ) d μ$$

where K(μ,λ) is a real-valued function with the properties K(μ,λ)=K(λ, μ) and K(λ,λ)=1.

A useful example of a kernel well suited for MOFF is the cosine kernel, defined as

K(μ,λ)≡cos(2(μ−λ))

Throughout this document, we will refer to the orientations computed above as MOFF orientations.

These orientations have periodicity 180 degrees when rotated around a point, opposed to a periodicity of 360 degrees for traditional gradient based vectors.

The weights for MOFF orientations do not rely on just intensity differences, but should be thought more of as a reliability measure of the orientation. On the other hand, gradient based orientations rely on the intensity difference between nearby pixels.

The orientations computed above have the unique property of pointing towards an edge when located outside an object, and along an edge when located inside an object. This is a major difference compared to gradient based orientations, which always point perpendicular with respect to an edge.

The orientation computed above, are remarkably insensitive to noise and artifacts. Gradient based orientations, even when combined with various blurring schemes, tend to be very sensitive to noise and artifact, especially for “thin” objects (such as curves with thickness of 1 pixel).

The MOFF orientations are particularly well-suited for describing, thin, line-like features. Gradient based orientations are well-suited for defining edges between larger regions.

First, an orientation computed using gradients have a notion of “forward and backwards”. This is often illustrated by adding an arrow tip to the line representing the orientation. The MOFF orientation, however, does not have a notion of “forward and backwards”, and is therefore more suitably depicted by a line segment without an arrow tip.

A second important property of the orientations presented in this document, is that MOFF orientations stress geometry rather than intensity difference when assessing the weight of an orientation. As a consequence, MOFF orientations will generate similar (strong) weights for two objects of the same orientation, even when they have different intensities. A useful feature of the MOFF orientations is that they point parallel to an object if located inside the object, and perpendicular to the edge if located outside the object. This happens regardless of the thickness of the object, and this property remains stable even for very thin, curve-like objects that gradient based orientations have problems with.

An example is shown in FIG. 2, which shows the original model at the top, and the orientation field at the bottom. Note the pointing of the orientation depends on whether it is inside or outside the object.

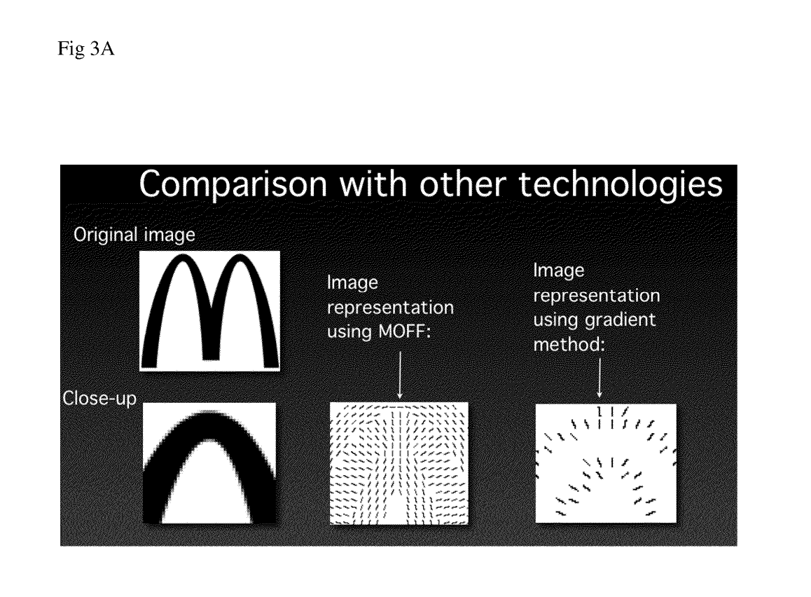

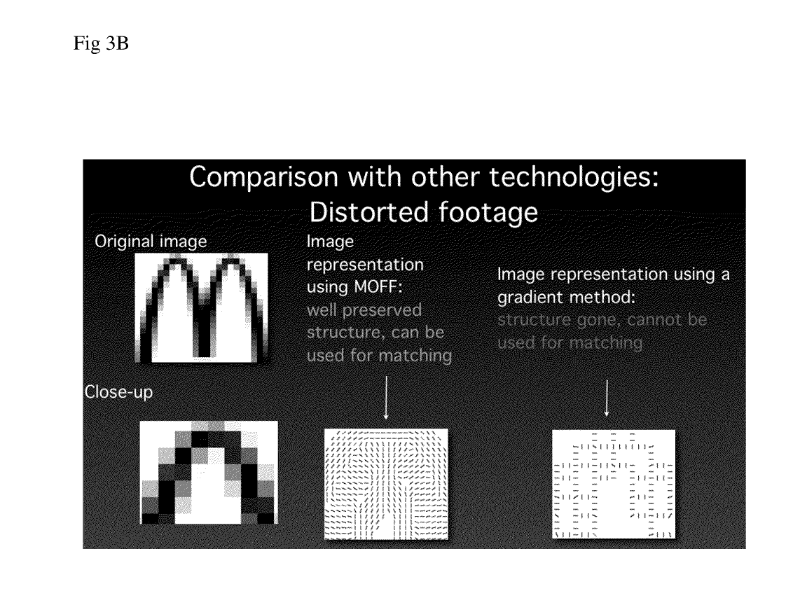

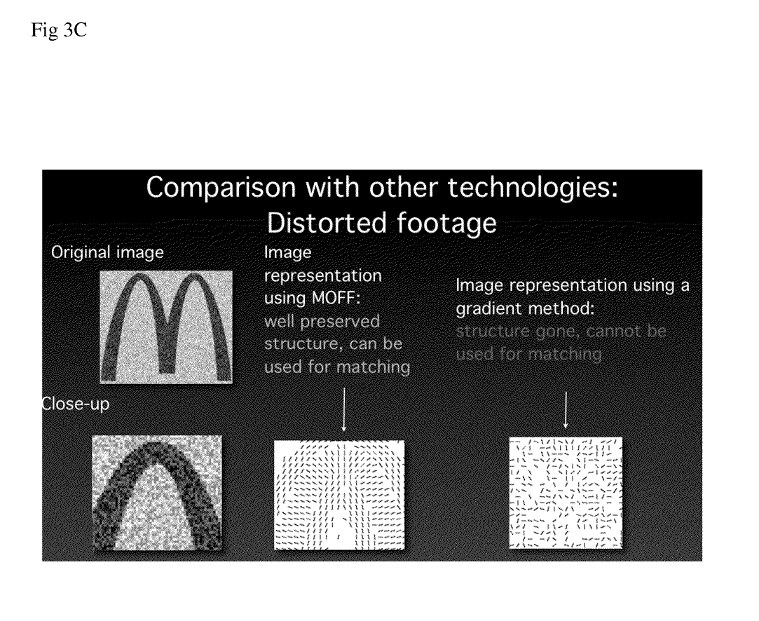

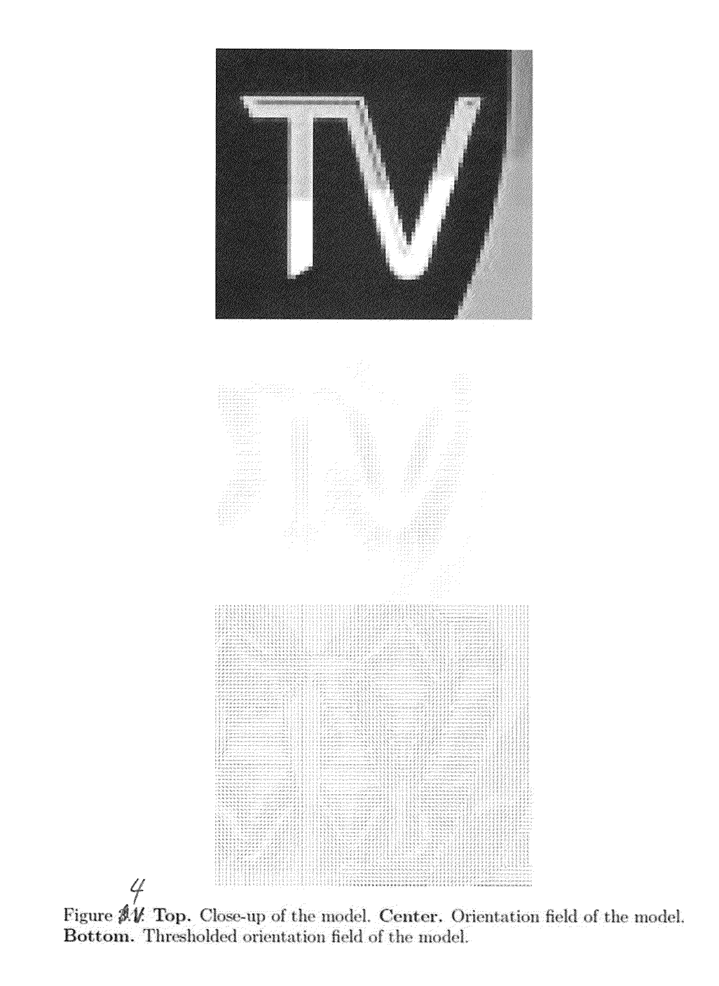

Another embodiment can be seen by comparing the orientation field around the McDonalds logo using MOFF orientations and gradient based orientations in FIG. 3A. This gets even more pronounced in a poorly resolved portion of the logo shown in FIG. 3B and in distorted footage, see FIG. 3C.

Although some of the shortcomings of the gradient based orientations can be overcome by introducing blurring and averaging techniques, such methods have their own problems. One drawback with such techniques is that blurring will decrease the intensity difference of legitimate structures as well, which makes the gradient computation less robust.

Although the weights of the MOFF orientations provide information about the reliability of the angle of the orientation, we do not use these reliability weights directly. We only use them to remove orientations which are deemed too unreliable. Typically, orientations with a reliability below 3% are removed this way. All remaining orientations are then given the same weight (which we set to 1). This is to remove all references to the intensity of the objects we want to detect. The intensity can vary greatly from image to image, whereas the underlying geometry, which are described by the orientation angles, are remarkably stable with respect to artifacts.

Since objects can appear in a wide variety of sizes, it is important to represent the objects in a “normalized” manner. When the techniques above are used to generate an orientation field of a line-like structure of width L, one can show that the reliability weight w of the orientation centered at such an object is maximized when using a scale L of approximately 4L. A similar relation holds in the vicinity of edges. Hence, if we maximize the average orientation weights for all pixels, we can find an optimal scale parameter, which then tells us the approximate width of the most prominent structures of the object(s) in the image.

To illustrate this, consider two images of the same object where one image is larger than the other. Let us say that the object appear as having thickness 2 pixels in the smaller image, and thickness 5 pixels in the larger image. The orientation field reliability will then be maximized by using scale 8 for the smaller image, and scale 20 for the larger image. By dividing the optimizing scale by 4, we can therefore estimate the true thickness of a structure in the image, without having to estimate it manually.

We next decide on a “common” scale. This common scale is chosen as the thickness of a “reference” structure. We don't want it to be too thin (say 1 pixel), for accuracy reasons, but not too large for efficiency reason. From experiment, it has been found that a reference thickness of about 2.5 pixels is a good compromise.

Returning to the example above, we then resize the orientation field from the smaller image by a factor of 2.5/2 in order to make the thickness of the object equal to roughly 2.5 pixels. We resize the larger image with a factor of roughly 2.5/8, in order to shrink the orientation field to the reference scale. After this procedure, the resized orientation field of the smaller and larger images now essentially coincide. See FIG. 4 for an illustration, where the top shows a Close-up of the model, the center shows the orientation field of the model, and the bottom shows the thresholded orientation field of the model.

Note that this “normalization” procedure does not create a scale invariant representation of the objects in the sense scale invariance is used for key-point based methods. The normalization procedure described above, only normalizes the widths of the structure, but does not normalize the overall size of the object, which SIFT-like methods do.

After the orientation field for both the model and the target have been computed and normalized as described above, the orientation fields are thresholded such that the weights that are almost zero (weights that are about 3%) of the max weight in the image, are set to zero. All other orientation weights are set to 1.

To compute the match map of the model with respect to the target, the thresholded model orientation field is now matched with the thresholded target orientation field in a convolution style algorithm. However, whereas traditional convolution involves scalar multiplication of the two input vectors, in our case we measure the alignment between orientations in the two input vectors. Mathematically, we can express this match at pixel (i,j) as

$$C ( i , j ) = {\sum }_{k = 1}^{M} {\sum }_{l = 1}^{N} {w}_{target} ( i - \frac{M}{2} + k , j - \frac{N}{2} + l ) {w}_{model} ( k , l ) cos ( 2 ( {θ}_{target} ( i - \frac{M}{2} + k , j - \frac{M}{2} + l ) - {θ}_{model} ( k , l ) ) )$$

where C denotes the match map, and M-by-N is the dimension of the model orientation field.

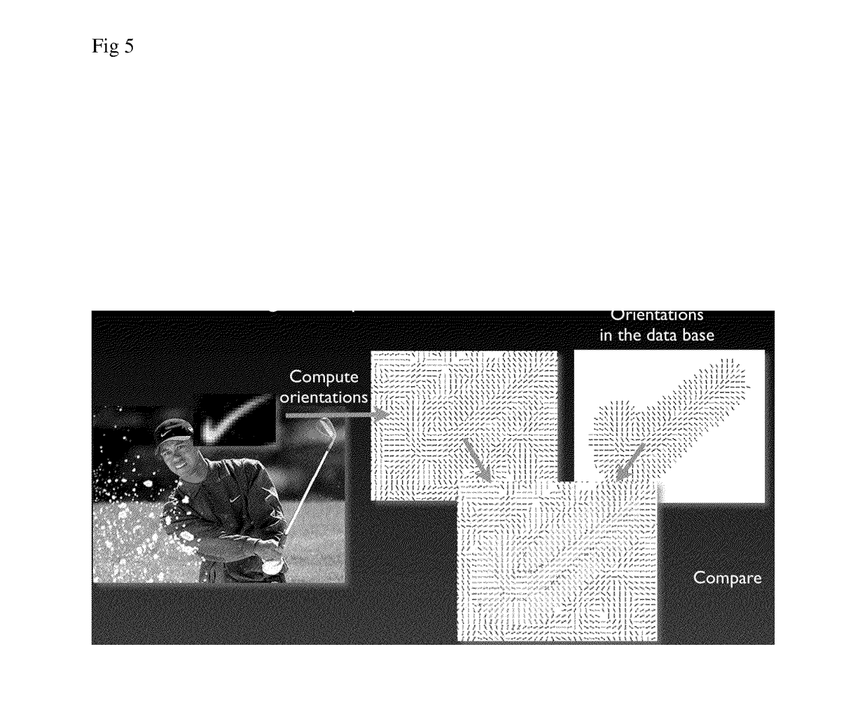

In order to illustrate this formula, we will look at detecting the Nike logo in an image. The Nike logo is due to its lack of detail a notorious example of where key-point based methods fail. In FIG. 5 we have shown the orientation field of the logo computed from the target image compared with the orientation field pre-computed in our data base. We then overlay the two orientation field, and measure the alignment at all points. We illustrate a high degree of alignment of with the color green.

The summation formula above that computes the match map, effectively computes this overlay around each pixel in the image. It then sums all the individual alignments to give the net alignment at a pixel in the target image.

It is worth mentioning, that although a different type of orientation is used for matching in SIFT-like methods, the matching in such methods are done in a significantly different way. In SIFT-like methods, one often creates a histogram (statistics) of orientations in a neighborhood of the key-points and collects the resulting numbers in a short array of numbers forming the descriptor at the key-point.

In MOFF, we do not use key-points nor local image descriptors. We also do not rely on histograms, which only records certain local statistics of the orientations. In our case, we compare the orientations globally, using an alignment measure that is not used by SIFT. Later on in this section, we will also look at an additional measure that one can add, which measures the auto-correlation between orientation field. The auto-correlation has no counterpart in SIFT-like algorithms.

The algorithm for computing the match at a pixel (i,j) can now be described as follows. Let the size of the rescaled model orientation field be given by modelSizeY and modelSizeX. The match for a pixel i,j in the rescaled target image is then computed by the following algorithm:

| | |
|---|---|
| 1. | matchMap[i,j]=0 |
| 2. | For k=0,1,...,modelSizeY−1 |

| | |
|---|---|
| (a) | index1=i−modelSizeY/2+k |
| (b) | For l=0,1,...,modelSizeX−1 |

| | |
|---|---|
| i. | index2=j−modelSizeY/2+1 |
| ii. | matchMap[i,j] += thresholdedModelWeights[k,l]* |
| | thresholdeTargetWeights[k,l]* |
| | cos(2*(thresholdedModelAngles[k,l]− |
| | thresholdedTargetAngles[k,l])) |

| | |
|---|---|
| 3. | matchMap[i,j] /= modelArea |

Here modelArea is a normalization constant which is set to the number of non-zero weights in the model orientation field.

We can reduce the number of false positives significantly for certain types of objects, by also measuring the auto-correlation of the orientation field. The auto-correlation A of an orientation field at a pixel (i,j) can be computed by

A_{(i,j)}(k,l)=w(i−k,j−l)w(k,l)cos(2(θ(i−k,j−l)−θ(i,j)))

for k, l=−r,−r+1, . . . , r where r is a parameter that determines over how large area to auto-correlate the orientation field. The auto-correlation matrix can then be stored along with the pre-computed orientation field for each model.

The auto-correlation can now be used as follows. We first generate the match map C. For each pixel (i,j) where we have a large match value, we now extract the a sub-matrix C, by extracting the elements C(k,l), where k=i−r,i−r+1, . . . ,i+r and l=j−r,j−r+1, . . . ,j+r, and store them as a matrix B(i,j).

We note that if the target image contained an exact copy of the model, this sub matrix would be identical to the auto-correlation matrix A. Hence, the difference between A and B gives an additional measure how similar the model is to the detected object around pixel (i,j) in the target image. This measure is particularly powerful for certain “simple” objects, such as rectangles and gun shapes. Hence, we can apply thresholding to the difference of A and B, measured by some suitable norm.

The final measure to use to establish if we have a match at pixel (i,j) is now given by

M(i,j)=(1−a)C(i,j)+a∥A−B_{(i,j)}∥

where C(i,j) is computed from Equation above, A is the auto-correlation for the model computed from Equation above, and B(i,j) is the sub-matrix extracted around the neighborhood of C(i,j) as described above. Here we have also introduce a parameter a, which determines how much weight we want to “reward” the alignment C(i,j) for the final measure, vs. how much we want to “reward” high auto-correlation. For example, if a=0, we only use the alignment measure, and if a=1 we only use the auto-correlation measure. If a=0.5, we put equal weights for alignment and auto-correlation.

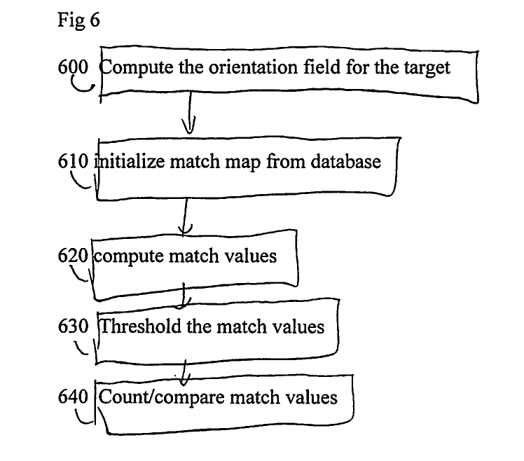

The overall process is therefore as follows, and as shown in the flowchart of FIG. 6.

At 600, Compute the orientation field for the target image using Equation above:

$$w ( x ) = {max}_{φ ∈ [ 0 , π )} {\int }_{0}^{π} K ( φ , μ ( x ) ) S ( x , μ ) d μ \\ θ ( x ) = arg {max}_{φ ∈ [ 0 , π )} {\int }_{0}^{π} K ( φ , μ ( x ) ) S ( x , μ ) d μ \qquad ( 1 )$$

T 610, For each model in the data base, initialize a final match map as a matrix M with the same size as the original image with zeros everywhere.

For each 3D pose:

For each size:

At 620, Compute the match value at each pixel using Equation

M(i,j)=(1−a)C(i,j)+a∥A−B_{(i,j)}∥.

This will result in a temporary match map, which we refer to as Mtmp.

At 630, Threshold the match values based on a certain percentage of the max match value in Mtmp.

At 640, count the number local max in the thresholded Mtmp. If the number of local max is smaller than a threshold, this indicates that we have “rare” event, which means we likely have detected a matching object.

For all local max coord (i,j) detected in the previous step:

If the match value Mtmp(i,j) is greater than a threshold,

From index location (i,j) in the Mtmp, compute of the corresponding location with respect to the original image size, and denote the new coordinates as (i′,j′)

Add the match to the final match map: M(i′,j′)=M(i′,j′)+M(i,j)

else

Continue

] else

Continue

Threshold the final match map M. Any points above the threshold are recorded as a match of the current model.

In order to make the algorithm more efficient we present a number of improvements to the full algorithm that significantly reduces the computational cost.

It is typically useful to compute the orientation field for a number of different scales L. In the this section we present an algorithm for generating the orientation field for all intermediate scales L=2, 3, . . . , Lmax for roughly the same cost as computing the orientation field with respect to only scale Lmax.

To this end, we introduce a scale subscript L to the integral S that was used for computing the orientation field

$${S}_{L} ( x , θ ) = {\int }_{- \frac{L}{2}}^{\frac{L}{2}} I ( x + {r}_{θ} ( s ) ) d s$$

Computing the integral

O_{L}(x)=∫₀^{2π}K(φ,μ(x))S_{L}(x,μ)dμ

for each pixel is the most computationally expensive part of computing the orientation field in Equation (1). However, we note that the combination of the integral OL and SL can be written as the double integral

$${O}_{L} ( x ) = {\int }_{0}^{π} {\int }_{- \frac{L}{2}}^{\frac{L}{2}} K ( φ , μ ( x ) ) I ( x + {r}_{θ} ( s ) ) d s d μ$$

or, equivalently, as

$${O}_{L} ( x ) = {\int }_{0}^{2 π} {\int }_{0}^{\frac{L}{2}} K ( φ , μ ( x ) ) I ( x + {r}_{θ} ( s ) ) d s d μ$$

We now note that this integral has the “nesting” property

$${O}_{L + Δ L} ( x ) = {O}_{L} ( x ) + {\int }_{0}^{2 π} {\int }_{\frac{L}{2}}^{\frac{L}{2} + Δ L} K ( φ , μ ( x ) ) I ( x + {r}_{θ} ( s ) ) d s d μ$$

This means that in order to compute the integral O with respect to a larger scale, we can use the result from a smaller scale, and just add the contribution from the integral integrated over a thin ring. This procedure computes the orientation fields for all scales L=2, 3, . . . , Lmax for essentially the same cost as computing the orientation field for only scale Lmax.

Another simplification is Processing Coarser Scales First

Due to the normalization method described above, orientation fields computed with respect to larger scales are effectively down sampled to a coarser grid. By looking for matches on a coarser grid, one can get a rough idea where potential matches are located, and if they are located in the image. Also, by looking at the coarser scales first, one can often determine which objects that with high certainty are not in the image, and remove these from further consideration.

This means that one can do a fast search for matches on a coarser scale, with low resolution of the original image, and then only look for matches on finer scales in areas where potential matches were recorded on the coarser scale. On the finer scales, one typically only have to search for a small fraction of all the models in the data base, as one can typically remove many models from the search by looking at the match results at coarser scales.

Matching by Nested Subsets.

Instead of immediately computing the alignment for all pixels (k,l) in the summation in Equation (2) described above, we introduce the notion of nested subsets. We start by defining a set consisting of all pixels summed over by Equation (2), which we define as

$${O}_{L} ( x ) = {\int }_{0}^{2 π} {\int }_{0}^{\frac{L}{2}} K ( φ , μ ( x ) ) I ( x + {r}_{θ} ( s ) ) d s d μ$$

where M and N denote the vertical and horizontal size of the model.

We next introduce notation for a sequence of subsets nested such that each subset is a proper subset of another one:

Λ₁⊂Λ₁⊂ . . . ⊂Λₙ⊂Λ

We do not specify exactly how we select the set. The key is that this generates an ordered sequence of sets with an increasing number of pixels coordinates in each set. We now define the match with respect to subset m at pixel (i,j) as

$${C}_{m} ( i , j ) = {\sum }_{( k , l ) ∈ {Λ}_{m}} {w}_{target} ( i + k , j + l ) {w}_{model} ( k , l ) cos ( 2 ( {θ}_{target} ( i + k , j + l ) - {θ}_{model} ( k , l ) ) )$$

When computing the match Mtmp in the algorithm in Section 5.1.3, we can now replace that step by the following algorithm:

For subset index m=1, 2, . . . , n−1:

Compute Cm(i,j) using Equation (5)

If Cm(i,j) is greater than a threshold

Continue the loop

else

Exit the loop, and continue to the next size of the main loop.

This means that for a great majority of the pixels, we will only compute the match using only a small fraction of all pixels in the model. We then only compute more contribution for the match if we appear to have a match based on the smaller subset of pixels.

We also note that we can “nest” the computations of Cm(i,j). We can compute Cm(i,j) from Cm−1(i,j), by only computing the sum in Equation (5) over the indices given by the difference of two consecutive subsets m and m−1.

Only Compute the Match Value C for Significant Pixels.

We note that objects are only likely to be detected in the vicinity of reliable orientations. Hence, we can first threshold the orientation weights of the target image, and only look for matches in neighborhoods of pixels that contain weights above a certain threshold. This typically mean that we only have to compute the match C(i,j) for a few percent of all the pixels in the image, providing huge saving in computations.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example while the above describes only certain kinds of detections using this technique, it should be understood that there are many more kinds of applications. This can be used to find, for example, logos and advertisements or in videos of various sorts. In sports, this can be used to find logos on team jerseys or numbers on the team jerseys

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general purpose processor or computer, a Digital Signal Processor (DSP), an Application Specific Integrated Circuit (ASIC), a Field Programmable Gate Array (FPGA), Graphical Processing Units (GPUs) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form. This may include laptop or desktop computers, and may also include portable computers, including cell phones, tablets such as the IPAD™, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of recognizing a target object in a target image, comprising:
using a computer for determining an orientation field of at least plural pixels of the target image, where the orientation field describes pixels at discrete positions of the target image being analyzed according to an orientation and location;
mapping the orientation field against an orientation field in model images in a database to compute match values between the orientation field or the target image and orientation field of model images in the database;
thresholding the match values against a threshold; and
counting those match values that exceed the threshold to determine a match between the target and the model.

2. The method as in claim 1, further comprising determining a common scale for both the model and the target, and changing all images to represent said common scale.

3. The method as in claim 2, wherein said common scale is set to 2.5 pixels.

4. The method as in claim 2, wherein said threshold is above 3% of a minimum weight.

5. The method as in claim 1, wherein said orientation field is one that points parallel to an object when inside the object and points perpendicular to the object when located outside the object.

6. The method as in claim 1, wherein said mapping comprises measuring an alignment between orientations of vectors.

7. The method as in claim 1, wherein the orientation field has a periodicity of 180 degrees when rotated around a point.

8. The method as in claim 1, wherein the orientation field is a tuple {w,θ}, where w is a real valued scalar, and θ is an angle in an interval [0, π), formed by generating an integral field S of an image I by
$$S ( x , θ ) = {\int }_{- \frac{L}{2}}^{\frac{L}{2}} I ( x + {r}_{θ} ( s ) ) d s$$
and determining the tuple as:
$$w ( x ) = {max}_{φ ∈ [ 0 , π )} {\int }_{0}^{π} K ( φ , μ ( x ) ) S ( x , μ ) d μ$$
$$and$$
$$θ ( x ) = arg {max}_{φ ∈ [ 0 , π )} {\int }_{0}^{π} K ( φ , μ ( x ) ) S ( x , μ ) d μ$$
where K(μ,λ) is a real-valued function with properties K(μ,λ)=K(λ, μ) and K(λ,λ)=1.
wherein
K(μ,λ)≡cos(2(μ−λ)).

9. The method as in claim 1, wherein said computing match values computes an autocorrelation of the orientation field.

10. The method as in claim 9, wherein said autocorrelation comprises establishing a match at pixel (i,j) by
M(i,j)=(1−a)C(i,j)+a∥A−B_{(i,j)}∥
where C(i,j) is a match map computed as
$$C ( i , j ) = {\sum }_{k = 1}^{M} {\sum }_{l = 1}^{N} {w}_{target} ( i - \frac{M}{2} + k , j - \frac{N}{2} + l ) {w}_{model} ( k , l ) cos ( 2 ( {θ}_{target} ( i - \frac{M}{2} + k , j - \frac{M}{2} + l ) - {θ}_{model} ( k , l ) ) ) ,$$
A is an auto-correlation for the model computed as
A_{(i,j)}(k,l)=w(i−k,j−l)w(k,l)cos(2(θ(i−k,j−l)−θ(i,j))), (3)
and B(i,j) is a sub-matrix extracted around a neighborhood of C(i,j) a is a parameter which determines how much weight to give alignment C(i,j) for a final measure, versus an amount of auto-correlation. where, if a=0, only an alignment measure is used, and if a=1, only an auto-correlation measure is used, and if a=0.5, alignment and auto-correlation are equally weighted.

11. A method for generating stable image descriptors for object recognition, which are stable with respect to variations in color, contrast, and lighting, and various image artifacts, the method comprising:
using a computer for generating orientation angles between 0 and 180 degrees at each of a plurality of pixel locations based on line integration;
using the computer for generating orientation weights, which indicates a reliability of the computed orientation angle using line integration; and
assigning all orientations with weights above a certain threshold weight as being active, and all orientations with weight below a certain threshold as being inactive.

12. A method for generating a scale invariant representation of an orientation field, the method comprising:
for multiple scales, compute average orientation weights for all pixels of at least part of an image;
selecting a scale that maximizes the average orientation weights; and
re-sizing the orientation field based on a relation between an optimal scale and a pre-determined reference scale.

13. A method for measuring a correlation of two orientation fields 1 and 2, the method comprising:
Compute an alignment between an in orientation field 1 and an orientation in orientation field 2, and assign the alignment a value between −1 and 1, where −1 indicates that an orientation angle 1 of orientation field 1 is perpendicular to an orientation angle 2 of orientation field 2 where, 1 indicates that orientation angle 1 and 2 are parallel, and
0 indicates that the orientations differ by 45 degrees or that at least one of the two orientations have weight 0;
Computing an average alignment of all orientations of orientation field 1 and a corresponding orientations in orientation field 2.
